(19) United States
(12) Patent Application Publication
(10) Pub. No.: US 2026/0168475 A1
(43) Pub. Date: Jun. 18, 2026

(54) HARVESTING ENERGY FROM BODIES EXPERIENCING WAVE MOTION

(71) Applicant: Toyota Motor Engineering & Manufacturing North America, Inc., Plano, TX (US)

(72) Inventors: Taehwa Lee, Ann Arbor, MI (US); Xiaopeng Li, Ann Arbor, MI (US); Ziqi Yu, Ann Arbor, MI (US)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 18/981,787

(22) Filed: Dec. 16, 2024

(51) Int. Cl. F03B 13/20

(52) U.S. Cl. CPC F03B 13/20; F05B 2220/709

(57) ABSTRACT

Systems, methods, and other embodiments described herein relate to harvesting circular motion, such as from waves in the ocean. In one embodiment, an energy harvesting device includes a cantilevered shaft attachable horizontally to a body experiencing wave motion. A resonator mass is attached to a free end of the cantilevered shaft. The resonator mass moves with circular motion as the body experiences the wave motion. The energy harvesting device also includes an energy conversion system operatively coupled to the cantilevered shaft. The energy conversion system generates electrical energy from two orthogonal motion components of the circular motion of the resonator mass. The energy harvesting device also includes an energy storage device to store the electrical energy.

### TECHNICAL FIELD

The subject matter described herein relates, in general, to harvesting energy from bodies experiencing wave motion and, more particularly, to an energy harvesting device that harvests energy from multiple movement components of a body experiencing wave motion.

### BACKGROUND

Energy consumption around the globe is on the rise. Many of the devices used daily in the world run on electricity. Some energy sources, such as fossil fuel sources, generate electricity in a way that may be harmful to the environment. Other energy sources, such as nuclear sources, may be more efficient and environmentally friendly, but the infrastructure to support these sources may be complex and costly. Another energy class is energy derived from natural resources or renewable energy. Engineers have developed systems that harness energy from naturally occurring phenomena. For example, turbines may be powered by wind or flowing water. As another example, hot water from geothermal reservoirs may turn turbines to generate electricity. Still further, solar panels convert energy from the sun into electricity. Given their infinite capability and eco-friendly nature, renewable energy sources are highly desirable. Accordingly, energy consumption sources that could be powered by renewable energy or the additional harvesting of environmental energy may only enhance the energy collection/distribution network.

### SUMMARY

In one embodiment, example devices and systems relate to a manner of improving the harvesting of renewable energy, specifically converting the wave motion of an object into electricity. In one embodiment, an energy harvesting device is described. The energy harvesting device includes a cantilevered shaft attachable horizontally to a body experiencing wave motion. The energy harvesting device also includes a resonator mass attached to a free end of the cantilevered shaft. The resonator mass moves circularly as the body experiences the wave motion. The energy harvesting device also includes an energy conversion system operatively coupled to the cantilevered shaft. The energy conversion system generates electrical energy from two orthogonal motion components of the circular motion of the resonator mass. The energy harvesting device also includes an energy storage device to store the electrical energy.

In one embodiment, an energy harvesting device is described. The energy harvesting device includes a cantilevered shaft attachable horizontally to a body experiencing wave motion. The cantilevered shaft is perpendicular to the direction of the wave motion of the body. The energy harvesting device also includes a resonator mass attached to a free end of the cantilevered shaft. The resonator mass moves with circular motion as the body experiences the wave motion. The axis of the circular motion is perpendicular to the wave motion of the body. The energy harvesting device also includes an energy conversion system operatively coupled to the cantilevered shaft. The energy conversion system generates electrical energy from a first orthogonal motion component of the circular motion of the resonator mass and a second orthogonal motion component of the circular motion of the resonator mass. The energy harvesting device also includes an energy storage device to store the electrical energy.

In one embodiment, a buoy is described. The buoy has an internal volume and experiences wave motion. The buoy also includes an energy harvesting device. The energy harvesting device includes a cantilevered shaft attachable horizontally to a body experiencing wave motion. The cantilevered shaft is perpendicular to the direction of the wave motion of the body. The energy harvesting device also includes a resonator mass attached to a free end of the cantilevered shaft. The resonator mass moves with circular motion as the body experiences the wave motion. The axis of the circular motion is perpendicular to the wave motion of the body. The energy harvesting device also includes an energy conversion system operatively coupled to the cantilevered shaft. The energy conversion system generates electrical energy from a first orthogonal motion component of the circular motion of the resonator mass and a second orthogonal motion component of the circular motion of the resonator mass. The energy harvesting device also includes an energy storage device to store the electrical energy.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIGS. 1A-1D illustrates a buoy in which the energy harvesting device is disposed, subject to wave movement, according to an embodiment disclosed herein.

FIG. 2 illustrates a buoy in which the energy harvesting device is disposed, according to an embodiment disclosed herein.

FIGS. 3A-3D illustrate an energy harvesting device with piezoelectric patches harvesting energy from wave movement of a body, according to an embodiment disclosed herein.

FIGS. 4A-4E illustrate an energy harvesting device with a gear-based conversion system harvesting energy from wave movement of a body, according to an embodiment disclosed herein.

FIG. 5 depicts a buoy in which a dual-shaft energy harvesting device is disposed, according to an embodiment disclosed herein.

FIG. 6 depicts a buoy in which multiple single shaft energy harvesting devices are disposed around a sidewall of a buoy, according to an embodiment disclosed herein.

### DETAILED DESCRIPTION

Devices and systems associated with harvesting energy from bodies that exhibit wave movement are disclosed herein. As previously described, some bodies exhibit wave-like motion. As one particular example, a buoy may sit on the surface of water, such as in the ocean. The propagation of waves in the ocean causes the buoy to be displaced vertically. However, the buoy is not only displaced in a vertical direction but may angle up and down with respect to a reference horizontal plane as the buoy crests and falls over the waves, respectively. That is, the buoy's orientation relative to a vertical axis and a horizontal axis may change over time as waves propagate through the water. That is, while the buoy may not translate in a horizontal plane because of an anchoring tether, the buoy may change orientation in the horizontal plane. The system of the present specification harvests energy not only from the vertical movement of the buoy but also from the oscillating/swaying motion of the buoy in the horizontal and vertical planes. While particular reference is made to harvesting energy from a buoy exhibiting wave movement, the energy harvesting system may also harvest energy from other bodies that exhibit wave movement.

In general, the system includes a cantilevered shaft that extends from the surface of the body. In the example of a buoy, the cantilevered shaft may extend inward from a vertical sidewall of the buoy or from a vertical plate extending from the base of the buoy. In either case, the cantilevered shaft may be disposed on an interior volume of the buoy. A free end of the cantilevered shaft may move responsive to the wave-like movement of the body to which it is attached. For example, as a buoy angles up a rising edge and falls down a trailing edge of a wave, the cantilevered mass may exhibit a circular movement. A mass placed at the end of the cantilever amplifies this movement. The mass and cantilever act as a mechanical resonator that amplifies the motion, making energy harvesting more efficient. That is to say, the mass and cantilever provide mechanical movement that can be converted into electrical energy, and the weight of the mass amplifies the mechanical movement of the cantilevered shaft such that more electrical energy may be generated.

The mechanical movement of the mechanical resonator is harvested in a variety of ways via an energy conversion system. In one example, the energy conversion system includes piezoelectric patches on the orthogonal surfaces of the cantilevered shaft. The circular motion of the cantilevered shaft can be decomposed into two orthogonal components (e.g., an x-direction component and a y-direction component). Piezoelectric patches on orthogonal surfaces of the cantilevered shaft each harvest energy from one component of the cantilevered shaft's complex circular motion.

In general, piezoelectric material converts energy from a mechanical domain to an electrical domain. Specifically, the bending of the cantilever induces strain on the piezoelectric patches. The piezoelectric material converts this mechanical strain energy into electrical energy, thereby generating a voltage across the piezoelectric patches, which can be harvested and stored. The rise and fall of the body in a vertical direction induces a bending motion on piezoelectric patches positioned on the top and bottom surfaces of the cantilevered shaft. The angling of the body in the horizontal plane (e.g., as a buoy crests and falls over a wave) induces a bending motion on piezoelectric patches positioned on the side surfaces of the cantilevered shaft. The respective piezoelectric patches generate electrical power from these different wave motion components and provide such to an energy storage system, such as a capacitor or a battery.

In another example, the energy conversion system includes a series of gears coupled to an electric generator. Specifically, a shaft gear may include a radial slot where the cantilevered shaft sits. As the cantilevered shaft moves in a circular pattern, the interaction between the cantilevered shaft and the radial slot rotates the shaft gear. The shaft gear includes teeth that enmesh with the teeth of a generator gear. The enmeshment of the teeth causes the generator gear to rotate. The generator gear may be coupled to a generator that converts the rotational movement of the generator gear into electricity, which may be used by the buoy and/or stored for subsequent use.

Therefore, based on the piezoelectric effect or the operation of a generator, the present energy harvesting device generates electrical energy not only from the vertical movement of a body, such as a buoy, but also from the horizontal component of the body exhibiting wave motion, such as may occur as the buoy crests and falls over a surface ocean wave.

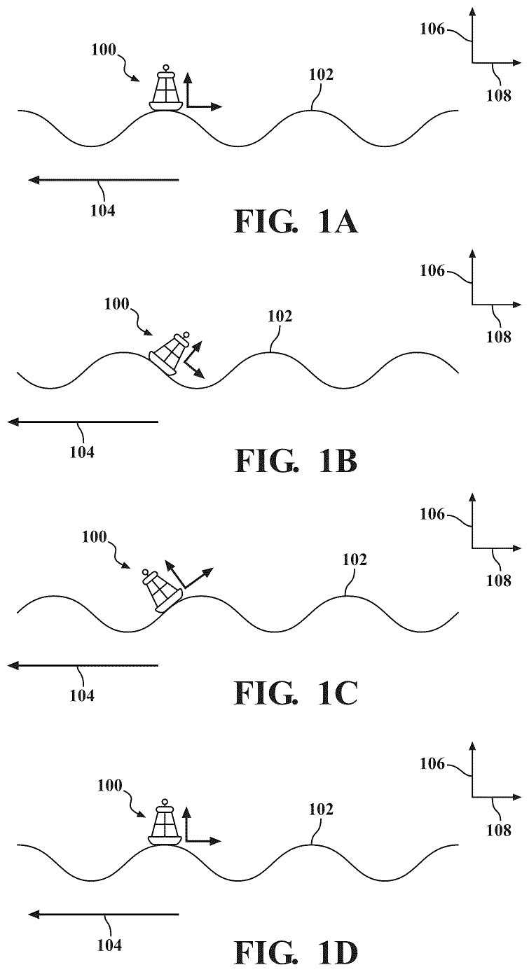

Turning now to the figures, FIGS. 1A-1D illustrates a buoy 100, in which the energy harvesting device is disposed, exhibiting wave motion, according to an embodiment disclosed herein. It will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements.

As described above, different bodies may exhibit different motions. One particular type of motion that a body may exhibit is wave motion, characterized by vertical translation and oscillation about a vertical axis and a horizontal axis. The movement of a buoy 100 across the top of a surface wave 102 is one example. As depicted in FIGS. 1A-1D, the buoy 100 may exhibit vertical translational movement and rotation about a reference vertical axis 106 and rotation about a reference horizontal axis 108. For example, as depicted in FIG. 1A when the buoy 100 is on the crest of the wave 102, the vertical axis of the buoy 100 may be generally aligned with a reference vertical axis 106, and the horizontal axis of the buoy 100 may be generally aligned with a reference horizontal axis 108. By comparison, as depicted in FIG. 1B, as the wave 102 propagates in a horizontal direction 104, the buoy 100 translates in a downward vertical direction as indicated in FIG. 1B. As the buoy 100 falls down a trailing side of the wave 102, the vertical and horizontal axes of the buoy 100 rotate relative to respective reference axes in a first direction, as indicated in FIG. 1B. As the wave 102 continues to propagate in the horizontal direction 104, the buoy 100 begins to translate vertically upward, as depicted in FIG. 1C. The propagation of the wave 102 also causes the vertical and horizontal axes of the buoy 100 to rotate relative to respective reference axes in a second direction, opposite the first direction, as indicated in FIG. 1C. As depicted in FIG. 1D, as the wave 102 continues to propagate, the buoy 100 again sits on the crest of the wave 102, where the vertical and horizontal axes of the buoy 100 are generally aligned with the reference vertical axis 106 and the reference horizontal axis 108, respectively. Thus, as depicted in FIGS. 1A-1D, the angular position of each of the buoy axes may exhibit a periodic oscillation back and forth with reference to respective vertical and horizontal axes 106 and 108, respectively, as the buoy 100 rises and falls over the crests and troughs of the waves 102. The energy harvesting devices described and depicted herein can harvest this wave motion. In other words, the present energy harvesting system not only harvests energy from the vertical translation of the buoy in a direction perpendicular to the horizontal direction 104 of the buoy 100 but also harvests energy from the cyclic oscillation of the buoy back and forth relative to respective vertical axes 106 and horizontal axes 108.

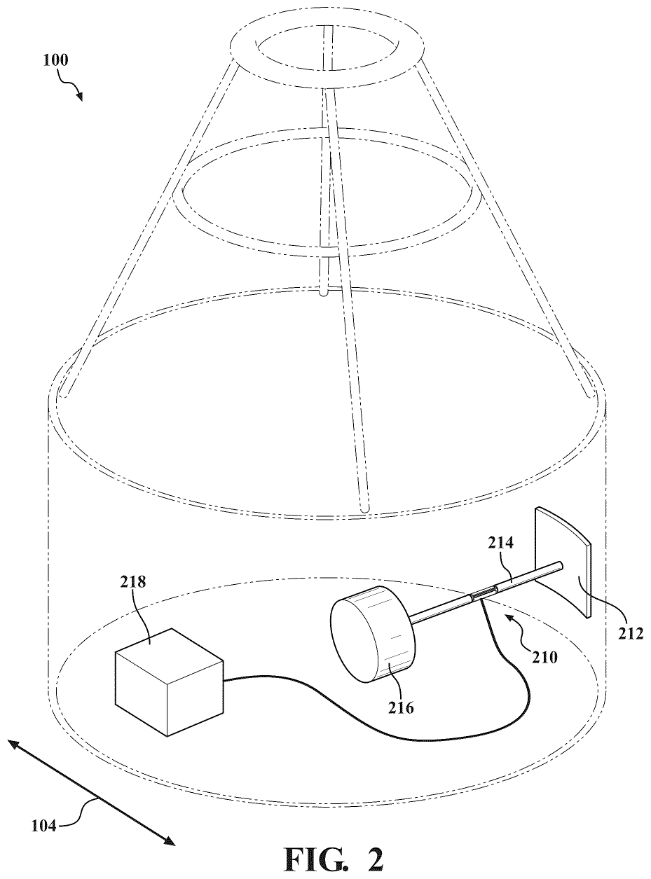

FIG. 2 illustrates a buoy 100, in which the energy harvesting device 210 is disposed, according to an embodiment disclosed herein. Note that in the figures that follow, certain components are not drawn to scale. For example, the energy harvesting devices have been enlarged to illustrate the details of these components.

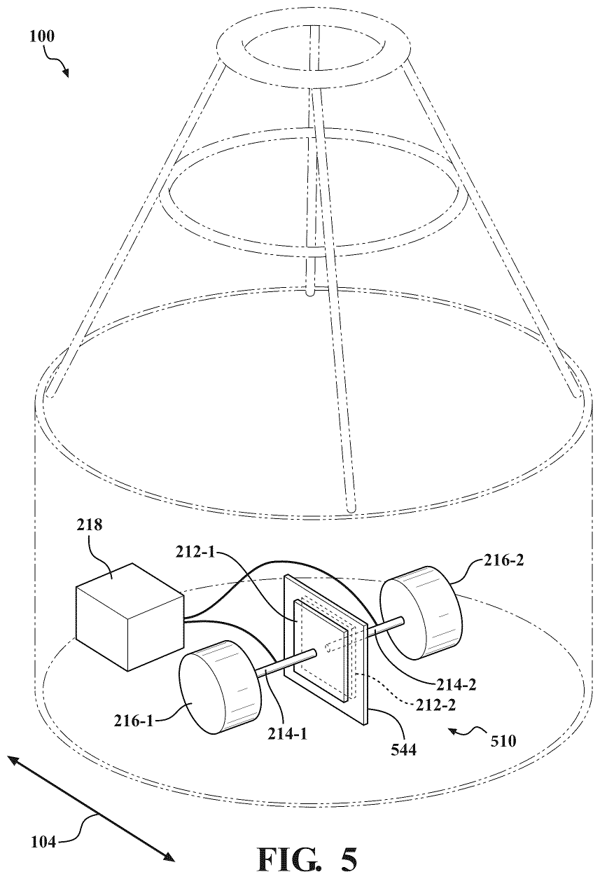

Returning to the figures, the buoy 100 includes a body with an internal volume. In an example, the energy harvesting device 210 (e.g., the cantilevered shaft 214 and the resonator mass 216) is disposed on the body within the internal volume. Doing so may protect the energy harvesting device 210 from mechanical damage, malicious tampering, and the forces of nature such as wind, rain, and saltwater. In other examples, such as that depicted in FIG. 5, the cantilevered shaft may be mounted to a vertical plate within the body.

The energy harvesting device 210 includes a cantilevered shaft 214 attachable horizontally to a body (e.g., a buoy 100) experiencing wave motion. Specifically, the energy harvesting device 210 may include a base affixed to an interior sidewall of the body, such as a buoy. The base 212 may be affixed to the body in any number of ways, including welding, riveting, or via mechanical fasteners such as bolts or screws.

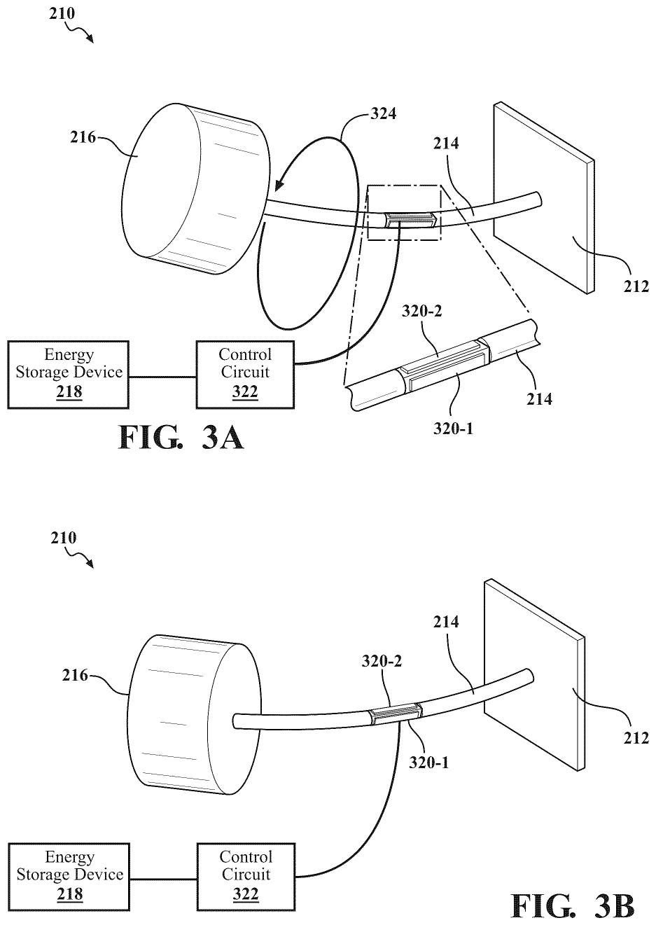

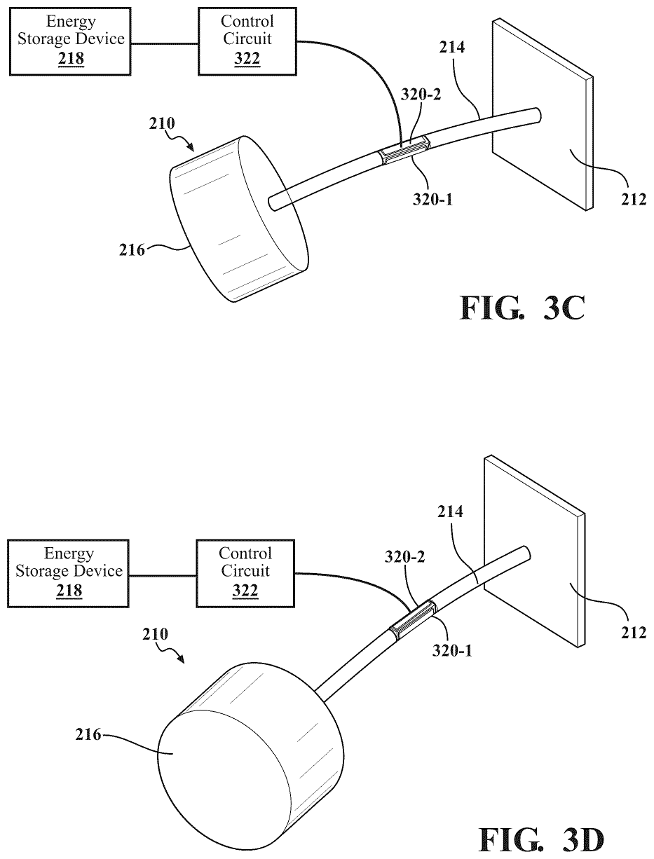

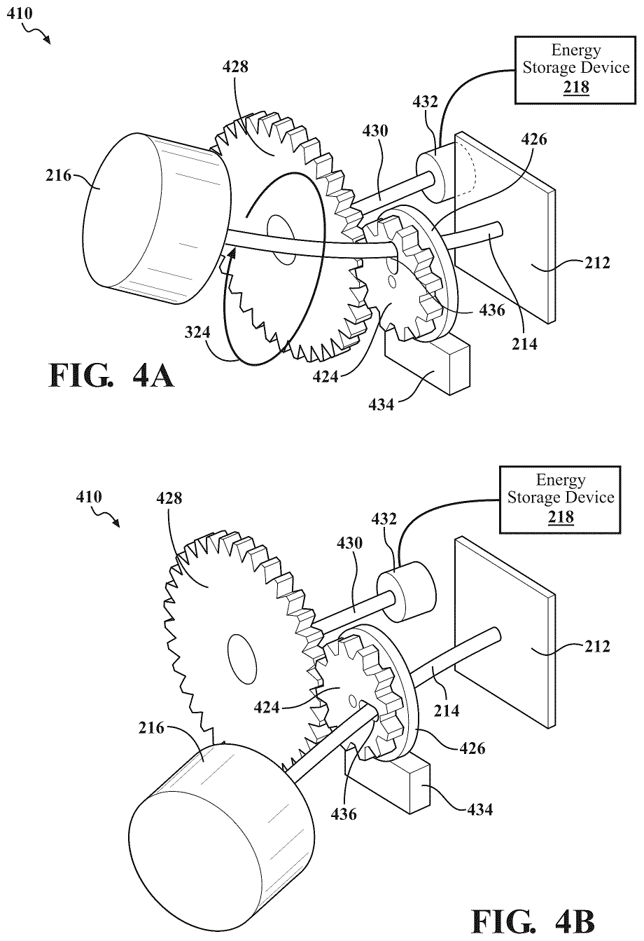

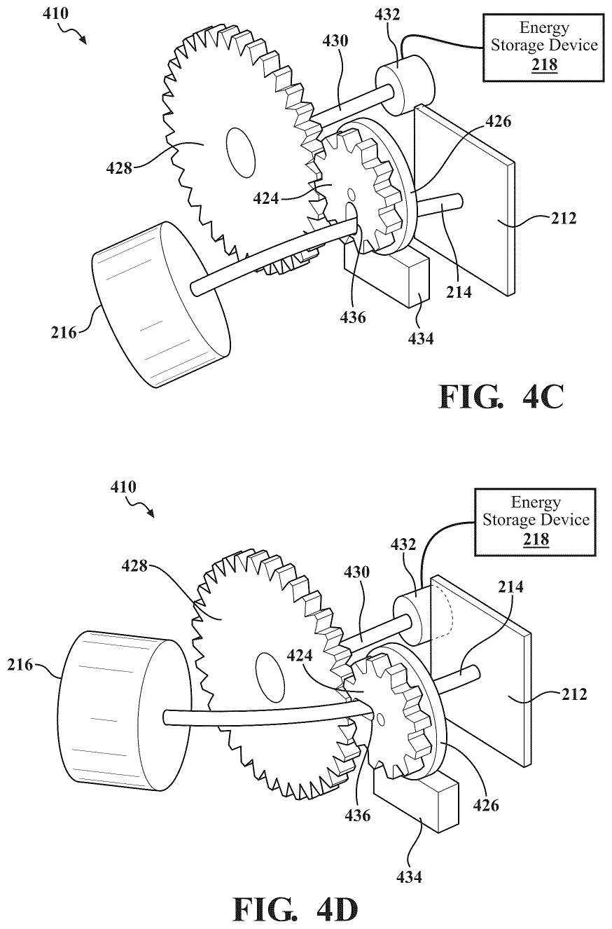

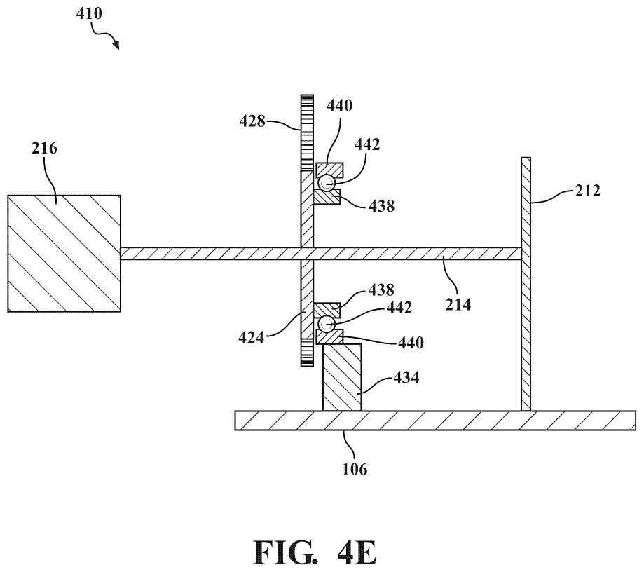

A resonator mass 216 is attached to a free end of the cantilevered shaft 214. The resonator mass 216 moves circularly as the body experiences the wave motion. That is, as the body translates up and down and/or oscillates about a reference vertical axis and a reference horizontal axis, as depicted in FIGS. 1A-1D, the resonator mass 216 moves in a circular pattern, as depicted in FIGS. 3A-3D. This movement can be harvested in a variety of ways and used to generate electrical energy. For example, as depicted in FIGS. 3A-3D, piezoelectric patches on the cantilevered shaft 214 generate electrical energy from the mechanical bending of the cantilevered shaft 214. By comparison, in the example depicted in FIGS. 4A-4E, mechanical energy is converted into electrical energy via a system of gears and an electrical generator.

In either case, the circular motion of the cantilevered shaft 214 and resonator mass 216 is harvested. The resonator mass 216 serves to amplify the motion to enhance the movement of the cantilevered shaft 214, thus increasing the energy harvesting potential. That is, the cantilevered shaft 214 itself may exhibit a circular motion as the body moves in a wave-like fashion. However, energy generation depends upon the deflection of the cantilevered shaft 214. The resonator mass 216 increases the deflection of the cantilevered shaft 214, thus increasing the energy generation capability of the system. In an example, the resonator mass 216 may be rigidly affixed to the cantilevered shaft 214. In another example, the resonator mass 216 may be selectively removable from the cantilevered shaft 214. As described below, in this example, the position of the resonator mass 216 along the length of the cantilevered shaft 214 may be adjusted. The cantilevered shaft 214 and the resonator mass 216 may be made of any rigid material, such as steel or aluminum.

In an example, the amount of energy harvested is maximized when the cantilevered shaft 214 and resonator mass 216 move according to a resonance frequency. The resonance frequency of a cantilevered shaft 214 and resonator mass 216 refers to the frequency where movement exhibits its highest amplitude. Thus, greater power is output when the wave motion of the body results in the cantilevered shaft 214 and resonator mass 216 moving in a circular pattern at resonance. Specifically, the frequency of the wave motion refers to the number of waves that pass a fixed point in a given amount of time. The circular movement of the cantilevered shaft 214 and the resonator mass 216 is maximized when the resonance frequency of the system matches the frequency of the waves.

The resonance frequency of the cantilevered shaft 214 and resonator mass 216 system is defined by its physical dimensions (e.g., its length, width, and mass). Accordingly, in an example, the physical dimensions of the cantilevered shaft 214 and the resonator mass 216 of the energy harvesting device 210 may be selected based on the detected frequency of the waves 102 that induce the circular motion of the cantilevered shaft 214 and resonator mass 216. Specifically, the cantilevered shaft 214 and the resonator mass 216 may have physical properties that result in a resonance frequency that aligns with the frequencies of the waves that drive the movement of the body.

The resonance frequency, f, For a cantilevered shaft 214 with a resonator mass 216 may be defined by Equation (1) below.

$$f = \frac{1}{2 π} \sqrt{\frac{k}{m}} . \qquad Equation ( 1 )$$

In Equation (1), k is the stiffness of the cantilever, and m is the tip mass. The stiffness of the cantilevered shaft 214 may be represented by Equation (2) below.

$$k = \frac{3 EI}{{L}^{3}} . \qquad Equation ( 2 )$$

In Equation (2), E is the Young's modulus, I is the moment of inertia, and L is the length of the cantilevered shaft 214. For a circular shaft having a diameter, D, the moment of inertia, I, is represented by Equation (3) below.

$$I = \frac{π {D}^{4}}{64} . \qquad Equation ( 3 )$$

Accordingly, the resonance frequency of the cantilevered shaft 214 with the resonator mass 216 may be adjusted by varying certain properties of the cantilevered shaft 214 and resonator mass 216, such as the mass, m, the cantilevered shaft 214 diameter, D, and the length, L, of the shaft, specifically the length, L, between the fixed end of the cantilevered shaft 214 and the resonator mass 216. Note that while particular reference is made to a cantilevered shaft 214 with a circular cross-section, cantilevered shafts 214 with different cross-sectional shapes may be implemented in accordance with the principles herein by implementing a shape-specific moment of inertia, I, equation.

The frequency of the waves 102 may be measured in various ways. For example, a floating sensor, including an accelerometer, may be positioned on the water's surface. The output of the accelerometer may indicate the number of waves that pass a point in a given time duration. In another example, such as when the energy harvesting device 210 includes a piezoelectric energy conversion system, the frequency of the wave motion may be determined by monitoring the voltage signals from piezoelectric patches on the cantilevered shaft 214. That is, the voltage output by a piezoelectric patch may be represented by Equation (4) below.

$$V = {d}_{31} ϵ {t}_{0} . \qquad Equation ( 4 )$$

In Equation (4), d₃₁ is the piezoelectric strain constant for the piezoelectric material, E is the strain, and to is the thickness of the piezoelectric material. The strain adjacent to a fixed end of the cantilevered shaft 214 may be represented by Equation (5) below.

$$ϵ = \frac{3 D δ}{{L}^{2}} . \qquad Equation ( 5 )$$

In Equation 5, 6 is the cantilever deflection, L is the length of the cantilevered shaft 214, and D is the diameter of the cantilevered shaft 214. Combining Equations (4) and (5), the voltage produced may a piezoelectric patch may be represented by Equation (6) below.

$$V ( t ) = \frac{{d}_{31} 3 D {t}_{0}}{{L}^{2}} δ ( t ) . \qquad Equation ( 6 )$$

Equation (6) indicates that the frequency of the output voltage, V(t), is proportional to the deflection δ(t) of the cantilevered shaft 214 and thus the wave motion. Accordingly, a system may monitor the wave motion through the voltage from the piezoelectric patch or another sensor, such as an accelerometer. The length, L, of the cantilevered shaft 214 can then be adjusted, thereby changing the stiffness of the cantilevered shaft 214 and the resonance frequency of the cantilevered shaft 214 and resonator mass 216. As such, the cantilevered shaft 214 and resonator mass 216 system properties may be adjusted to match the wave motion frequency, thus increasing energy harvesting efficiency by increasing the bending strain on the cantilevered shaft 214. Put another way, the resonator mass 216 may be positioned along the length, L, of the cantilevered shaft 214 so that a resonance frequency of the energy harvesting device 210 matches the frequency of the wave motion of the body. Note that while matching the resonance frequency of the cantilevered shaft 214 and resonator mass 216 increases the efficiency of energy harvesting, energy can still be harvested when the resonance frequency of the cantilevered shaft 214/resonator mass 216 is misaligned with the wave frequency, albeit the harvest efficiency may be reduced.

It may be the case that the body exhibits different frequencies of wave motion. For example, at different times of the day, the wave frequency may be greater than at other times. The energy harvesting devices described herein may account for this in various ways. In one example, multi-shaft energy harvesting devices may be implemented where the device includes multiple cantilevered shaft/resonator mass pairings, each oriented differently and/or structured to have different resonance frequencies.

In an example, the position of the resonator mass 216 is adjustable along the length, L, of the cantilevered shaft 214. For example, the cantilevered shaft 214 may have threads that engage with threads on an interior channel of the resonator mass 216. Accordingly, as the resonator mass 216 is rotated, the threads engage to change the position of the resonator mass 216 along the length, L, of the cantilevered shaft 214. As such, the effective length, L, of the cantilevered shaft 214, its stiffness, and the overall resonance frequency of the cantilevered shaft 214 and resonator mass 216 may be adjusted.

Note that this adjustment may be performed manually by an individual or automated via a motor. Note also that while particular reference is made to one type of adjustable resonator mass 216, other types of adjustable systems may be implemented in accordance with the principles described herein. For example, the cantilevered shaft 214 may be telescopic.

As depicted in FIG. 2, the cantilevered shaft 214 may be perpendicular to the direction of travel of waves 102 that generate the wave motion of the body. That is, as depicted in FIG. 2, the waves 102 may travel in a horizontal direction 104. To amplify the movement of the body and the energy harvesting device 210, the cantilevered shaft 214 may be positioned perpendicular to the direction of the travel of waves. As a result, an axis of the circular motion of the cantilevered shaft 214 and the resonator mass 216 is also perpendicular to the direction of travel of the waves 102 that generate the wave motion.

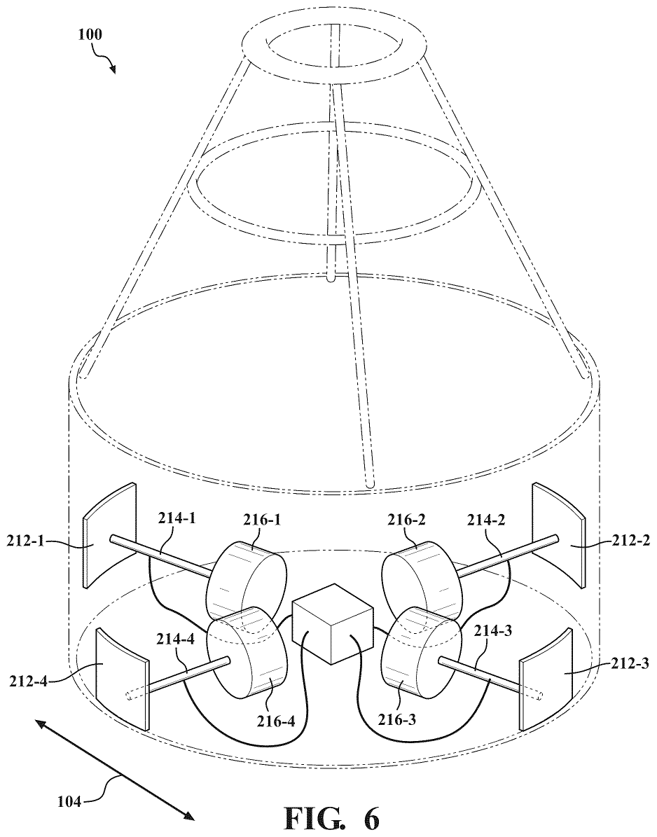

However, in some cases, the direction of the waves 102 may change over time. That is, in some cases, waves 102 may generally travel in a single direction, such as waves near a shoreline. In other examples however, the waves 102 may travel in different directions based on factors including prevailing winds, etc. To accommodate different directions of wave travel, the energy harvesting device 210 may include multiple instances of cantilevered shafts 214 and resonator masses 216, each oriented at different angles, as depicted in FIG. 6.

The energy harvesting device 210 also includes an energy conversion system operatively coupled to the cantilevered shaft 214. The energy conversion system generates electrical energy from two orthogonal components of the circular motion of the resonator mass 216. That is, as described above and as depicted in FIGS. 1A-1D, the body may exhibit wavelike motion, manifest as circular motion in the cantilevered shaft 214 and the resonator mass 216. This circular motion may be converted into two components: a first orthogonal component (i.e., a vertical or y-direction component) and a second orthogonal component (i.e., a horizontal or x-direction component). The energy conversion system generates electrical energy from this first orthogonal motion component of the circular motion of the resonator mass 216 and the second orthogonal motion component of the circular motion of the resonator mass 216. The energy conversion system may take a variety of forms. In the example depicted in FIGS. 3A-3D, the energy conversion system includes an array of piezoelectric patches. In the example depicted in FIGS. 4A-4E, the energy conversion system includes a series of gears and an electrical generator. In either case, the energy harvesting system may include an energy storage device 218 to store the electrical energy. The energy storage device 218 may be a battery that stores energy usable by a connected system (e.g., a buoy 100) or later retrieved and used for various purposes. In another example, the energy storage device 218 may be a capacitor. As such, the energy harvesting device 210 of the present specification efficiently harvests energy from the wavelike motion of a body, such as a buoy 100 that bobs across the top of waves 102 of the ocean.

FIGS. 3A-3D illustrate an energy harvesting device 210 with piezoelectric patches 320-1 and 320-2 harvesting energy from wave movement of a body, according to an embodiment disclosed herein. As described above, a piezoelectric device is a component that converts mechanical strain into electrical energy. In the context of the present specification, the piezoelectric patches 320-1 and 320-2 convert the circular motion of the cantilevered shaft 214 and the resonator mass 216 into electrical energy. Specifically, a patch of piezoelectric material positioned between electrodes is placed on the cantilevered shaft 214. As the cantilevered shaft 214 bends, a mechanical strain is induced on the piezoelectric material. This mechanical strain is converted to an electrical potential difference between the electrodes, which is collected, processed by a control circuit 322, and stored in an energy storage device 218, such as a battery or capacitor.

Accordingly, in this case, the energy conversion system includes a first piezoelectric patch 320-1 on the first side of the cantilevered shaft 214. The first piezoelectric patch 320-1 generates electrical energy from a horizontal motion component of the cantilevered shaft 214. The maximum horizontal deflection/strain may be when the cantilevered shaft 214 is in the position indicated in FIGS. 3B and 3D. However, there may be a horizontal component to the deflection of the cantilevered shaft 214 to any angular position. Similarly, the energy conversion system may include a second piezoelectric patch 320-2 on a second side of the cantilevered shaft. As depicted in FIGS. 3A-3D, the second side of the cantilevered shaft 214 is orthogonal to the first side of the cantilevered shaft 214. Accordingly, the second piezoelectric patch 320-2 generates electrical energy from a vertical motion component of the circular motion of the cantilevered shaft 214. The maximum vertical deflection/strain may be when the cantilevered shaft 214 is in the position indicated in FIGS. 3A and 3C. However, there may be a vertical component to the deflection of the cantilevered shaft 214 to any angular position.

Note that while FIGS. 3A-3D depict piezoelectric patches 320-1 and 320-2 on one vertical surface and one horizontal surface, similar piezoelectric patches may be placed on the other vertical and horizontal surfaces of the cantilevered shaft 214. Moreover, while FIGS. 3A-3D depict a single piezoelectric patch on each surface of the cantilevered shaft 214, additional instances of piezoelectric patches may be placed on each surface to increase the amount of electrical energy generated.

The structure of the piezoelectric patches 320-1 and 320-2 may vary. In general, a piezoelectric material is placed between two metal plates or electrodes. Examples of piezoelectric materials include a lattice of crystals (e.g., quartz and potassium nibonate), a ceramic (e.g., lead zirconate titanate (PZT), barium titanate, aluminum nitride), or a polymer film. When a force is applied to the material, in this case as the resonator mass 216 and wave motion bend the cantilevered shaft 214 in a circular motion as depicted in FIGS. 3A-3D, changes in the structure of the crystal lattice or the ceramic material induce the formation of an electric dipole within the piezoelectric material, which dipole produces a voltage across the piezoelectric material. For example, when strain is induced, the molecules may change position and align into a dipolar state, which produces the voltage. The electrodes collect the voltage.

As described in Equation (6) above, the output voltage, V(t), is defined in part by the deflection, δ(t), of the cantilevered shaft 214. The amount of electrical energy generated may be defined by Equation (7) below.

$$E = \frac{1}{2} {d}_{31}^{2} {E}_{pzt} A {ϵ}^{2} . \qquad Equation ( 7 )$$

In Equation (7), A is the cross-sectional area of the piezoelectric patch, and E_{pzt} is the Young's modulus of the piezoelectric material, which in this case is lead zirconate titanate (PZT).

Note that tension and compression of the piezoelectric patches 320-1 and 320-2 generate voltages of opposite polarity. For example, the second piezoelectric patch 320-2 on the top surface of the cantilevered shaft 214 may generate a voltage having a first polarity when compressed, as depicted in FIG. 3A, and may generate a voltage having a second polarity when under tension, as depicted in FIG. 3C. A piezoelectric patch on the bottom surface of the cantilevered shaft 214 may generate voltages with opposing polarities as those described above for the same motions on account of a bottom surface piezoelectric patch being under tension when the second piezoelectric patch 320-2 is in compression.

Similarly, the first piezoelectric patch 320-1 on a side surface of the cantilevered shaft 214 may generate a voltage having a first polarity when compressed, as depicted in FIG. 3B, but may generate a voltage having a second polarity when under tension, as depicted in FIG. 3D. A piezoelectric patch on the opposite side surface of the cantilevered shaft 214 may generate voltages with opposing polarities as those described above for the same motions on account of the opposite side surface piezoelectric patch being under tension when the first piezoelectric patch 320-1 is in compression. Accordingly, in these examples, each piezoelectric patch 320-1 and 320-2 may generate an alternating current on account of the oscillations depicted in FIGS. 3A-3D.

In an example, the energy conversion system includes a control circuit 322 to, among other things, convert the alternating current output from a given piezoelectric patch 320-1 and 320-2 to a direct current for storage and/or use. Accordingly, each piezoelectric patch 320-1 and 320-2 and, more specifically, the piezoelectric patches 320-1 and 320-2 electrodes may be coupled to a control circuit 322, which may include a power conditioning circuit.

In one example, the control circuit 322 includes a bridge rectifier to convert the alternating current (AC) voltage generated by the piezoelectric patches 320-1 and 320-2 into direct current (DC). The control circuit 322 may also include a smoothing capacitor to reduce ripples and provide a more stable DC voltage. In one example, the control circuit 322 includes a boost converter to increase the voltage to a higher level, which is suitable for powering devices or charging energy storage devices 218, like capacitors or batteries.

FIGS. 4A-4E illustrate an energy harvesting device 410 with a gear-based energy conversion system harvesting energy from wave movement of a body, according to an embodiment disclosed herein. That is, in this example, rather than relying on piezoelectric patches to convert mechanical energy into electrical energy, the energy conversion system is a gear and generator-based system. In general, the circular movement 324 of the cantilevered shaft 214 causes gears to rotate, which gears drive an electrical generator to generate electricity, which is then stored by an energy storage device 218 such as a capacitor or battery.

Specifically, the energy conversion system includes a shaft gear 424 with a radial slot 436 to receive the cantilevered shaft 214. Specifically, an interface between the cantilevered shaft 214 and the radial slot 436 causes the shaft gear 424 to rotate in a circular motion as the cantilevered shaft 214 and resonator mass 216 rotate in a circular motion. For example, as the cantilevered shaft 214 moves from a vertical position, as indicated in FIG. 4A to a horizontal position, as depicted in FIG. 4B, the cantilevered shaft 214 pushes against a wall of the radial slot 436, which causes the shaft gear 424 to rotate clockwise. As the cantilevered shaft 214 continues to rotate from the horizontal position indicated in FIG. 4B, through the vertical position depicted in FIG. 4C and the horizontal position depicted in FIG. 4D, and back to the vertical position depicted in FIG. 4A, the cantilevered shaft 214 continues to press against the wall of the radial slot 436 to drive the shaft gear 424 through one complete revolution.

Note that the cantilevered shaft 214 may be positioned at any radial distance within the radial slot 436 based on the amplitude of the circular motion 324 of the cantilevered shaft 214. For example, as described above, the amplitude of the waves 102 that drive the motion of the body and the energy harvesting device 410 change over time. The energy harvesting device 410 of the present example and the energy harvesting devices of the previous examples can harvest energy from various amplitudes of wave 102 energy. Put another way, the radial slot 436 facilitates changes to the amplitude of the circular motion 324 as the cantilevered shaft 214 may change radial position within the radial slot 436.

The shaft gear 424 has circumferential teeth that enmesh with the teeth of a generator gear 428. Accordingly, as the shaft gear 424 rotates in a clockwise direction that matches the circular motion 324 of the cantilevered shaft 214, the generator gear 428, on account of the enmeshment of corresponding teeth, rotates in a counterclockwise direction. Thus, the rotation of the cantilevered shaft 214 and the resonator mass 216 drives the rotation of the generator gear 428, which in turn drives the rotation of a generator shaft 430.

The gear-based energy conversion system may further include a rotary generator 432 operatively connected to the generator gear 428 via the generator shaft 430. In general, the rotary generator 432 generates electrical energy from mechanical energy via electromagnetic induction. In this example, the cantilevered shaft 214 drives the rotation of the generator shaft 430 via the shaft gear 424 and the generator gear 428. The rotary generator 432 may include an armature or electromagnet coupled to the generator shaft 430. That is, the rotation of the generator shaft 430 rotates the electromagnet or armature. This rotating electromagnetic spins inside a stationary stator inside the rotary generator 432 to generate an electrical current through copper wiring. As with the control circuit 322, the rotary generator 432 may transmit the generated electricity to an energy storage device 218, such as a capacitor or battery.

The gear-based energy conversion system may also include a bearing 426 having a stationary outer ring 440 coupled to a support base 434 for the shaft gear 424 and a rotating inner ring 438 coupled to a planar surface of the shaft gear 424. This bearing is depicted in cross-sectional form in FIG. 4E. Without such a support structure, the shaft gear 424 may move erratically responsive to the circular movement 324 of the cantilevered shaft 214. For example, the movement of the cantilevered shaft 214 from a vertical position, as depicted in FIG. 4A to a horizontal position, as depicted in FIG. 4B may exert a horizontal force on the shaft gear 424. Without this support structure, the shaft gear 424 may be influenced to translate horizontally. Such horizontal translation, even if on a small scale such as horizontal vibrations, may reduce the efficiency of the energy harvesting device 410 and may even lead to a malfunction of the device as the respective teeth of the shaft gear 424 and the generator gear 428 may no longer align with one another. As such, the support structure prevents the translational movement of the shaft gear 424 and instead guides the movement of the shaft gear 424 to be rotational around a longitudinal axis of the cantilevered shaft 214.

The stationary outer ring 440 may be affixed to the support base 434 in various ways, including welding or via fasteners. Similarly, the rotating inner ring 438 may be affixed to the shaft gear 424 in many ways, including welding or via fasteners. Note that in this case, while the inner ring 438 moves relative to the outer ring 440, the inner ring 438 does not move relative to the shaft gear 424, but rather moves in concert with the shaft gear 424.

The support structure ensures proper alignment and contact of the shaft gear 424 teeth with the teeth of the generator gear 428. Specifically, the support base 434 is rigidly affixed to a body surface, such as the base surface of the buoy 100. An outer ring 440 of the bearing is rigidly affixed to the support base 434. As depicted in FIG. 4E, an inner ring 438 is rigidly affixed to the shaft gear 424. Ball bearings 442 between the inner ring 438 and the outer ring 440 facilitate relative rotation of the outer ring 440 and the inner ring 438. This support structure allows the shaft gear 424 to rotate about an axis (i.e., the longitudinal axis of the cantilevered shaft 214, while not translating in any direction. Put another way, the bearing and associated support structure confine the movement of the shaft gear 424 to be rotational, thus preventing the loss of harvestable motion energy, which may occur were the shaft gear 424 allowed to translate. This increases the efficiency of the energy harvesting device 410 by controlling the movement of the shaft gear 424 so that the teeth of the shaft gear 424 are aligned with the teeth of the generator gear 428. Accordingly, the energy harvesting device 410 depicted in FIGS. 4A-4E depicts a gear and generator-based energy conversion system that converts the rotational movement of the cantilevered shaft 214 and resonator mass 216 into electrical energy.

FIG. 5 depicts a buoy 100, in which a dual-shaft energy harvesting device 510 is disposed, according to an embodiment disclosed herein. That is, the energy harvesting capability of the energy harvesting device 510 may be enhanced by including additional resonating members (e.g., multiple cantilevered shafts 214 and resonator masses 216). That is, multiple resonating members may increase the power output for a given body that exhibits wave motion. In one example, the different resonating members may be positioned at different angular orientations within the body, as depicted in FIG. 6. In another example, as depicted in FIG. 5, the different resonating members may be positioned to harvest wave motion generated by waves traveling in a same direction. That is, a first base 212-1, cantilevered shaft 214-1, and resonator mass 216-1 assembly may exhibit circular motion based on waves 102 traveling in a first direction and a second base 212-2, cantilevered shaft 214-2, and resonator mass 216-2 assembly may exhibit circular motion based on waves traveling in the same first direction.

In either example, the energy harvesting device 510 includes a second cantilevered shaft 214-2 attachable horizontally to the body. A second resonator mass 216-2 is attached to the free end of the second cantilevered shaft 214-2. As with the first resonator mass 216-1, the second resonator mass 216-2 moves with circular motion as the body experiences the wave motion. In this example, the energy harvesting device 510 includes a second energy conversion system operatively coupled to the second cantilevered shaft 214-2. The second energy conversion system generates electrical energy from two orthogonal motion components of the circular motion of the second resonator mass 216-2.

In one example, the resonating members may have different resonance frequencies. For example, a first resonator mass 216-1 may be placed a first distance away from the fixed end of the respective cantilevered shaft 214-1. The second resonator mass 216-2 may be placed a second distance away from the fixed end of the second cantilevered shaft 214-2, the second distance being greater than the first. Accordingly, each cantilevered shaft/resonator mass assembly may resonate and, therefore, maximally harvest energy from waves of different frequencies. Note that while particular reference is made to achieving multi-resonance based on different lengths of the respective cantilevered shafts 214, other properties of the cantilevered shaft/resonator mass assemblies (e.g., diameter, mass, etc.) may also be adjusted to facilitate multi-resonance. In any case, the dual-shaft energy harvesting device may harvest energy from more than one size/frequency of wave 102.

Moreover, while FIG. 5 depicts a single cantilevered shaft 214/resonator mass 216 assembly extending in either direction, in an example, more instances of the cantilevered shaft 214/resonator mass 216 assemblies may be positioned within the body in either direction.

In an example, the cantilevered shafts 214-1 and 214-2 and, more specifically, the bases 212-1 and 212-2 of the cantilevered shafts 214-1 and 214-2 may be mounted to a vertical interior surface 544 of the body. While FIG. 5 depicts the cantilevered shafts 214-1 and 214-2 extending from the vertical interior surface 544 at particular orientations, the cantilevered shafts 214-1 and 214-2 (and additional cantilevered shafts) may extend away from the vertical interior surface 544 at different angles.

Note that FIG. 5 depicts an example of an energy harvesting system with the energy conversion system removed for simplicity. However, in this example, either the piezoelectric patch 320-1 and 320-2 based energy conversion system or the gear and generator-based energy conversion system may be implemented in accordance with the principles described herein. In these examples, the energy conversion systems may be coupled to an energy storage device 218, such as a capacitor or a battery.

FIG. 6 depicts a buoy 100, in which multiple single shaft energy harvesting devices are disposed around an interior sidewall of the buoy 100, according to an embodiment disclosed herein. That is, in this example, the buoy 100 includes additional energy harvesting device(s) having additional cantilevered shafts 214 at different angular orientations. For example, the buoy 100 may include a first energy harvesting device with a first base 212-1, a first cantilevered shaft 214-1, and a first resonator mass 216-1. The first energy harvesting device may be placed at a first angular position around the interior sidewall of the body. Similarly, the buoy 100 may include a second energy harvesting device with a second base 212-2, a second cantilevered shaft 214-2, and a second resonator mass 216-2. The second energy harvesting device may be placed at a second angular position around the interior sidewall of the body. Similarly, the buoy 100 may include a third energy harvesting device with a third base 212-3, a third cantilevered shaft 214-3, and a third resonator mass 216-3. The third energy harvesting device may be placed at a third angular position around the interior sidewall of the body. Similarly, the buoy 100 may include a fourth energy harvesting device with a fourth base 212-4, a fourth cantilevered shaft 214-4, and a fourth resonator mass 216-4. The third energy harvesting device may be placed at a third angular position around the interior sidewall of the body. For simplicity, the energy conversion systems (i.e., piezoelectric patches 320 or gears/generators) have been omitted from FIG. 6. However, each energy harvesting device may be coupled to such a system as described above. In any case, the electrical energy generated by each energy harvesting device may be collected and stored in an energy storage device 218, such as a capacitor or battery.

By placing the different energy harvesting devices at different angular positions, energy from waves traveling in different directions may be harvested. For example, as described above, it may be that waves in a particular region generally travel in a single direction. For example, waves near a shoreline may generally travel towards the shoreline. However, in other embodiments, waves may travel in different directions at different times. An energy harvesting system with differently oriented energy harvesting devices may be able to harvest energy from waves, even though the wave propagation direction may change over time.

Moreover, in an example, different energy harvesting devices may be tuned to a different wave frequency, for example, by altering the respective resonator mass 216 position along a respective cantilevered shaft 214. Moreover, multiple energy harvesting devices may be placed at a particular angular orientation, with different energy harvesting devices at a particular angular orientation being tuned to different wave frequencies. In this example, the movement of waves with different frequencies and different directions may be harvested and converted into electrical energy.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-6, but the embodiments are not limited to the illustrated structure or application.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC, or ABC).

Aspects herein can be embodied in other forms without departing from the spirit or essential attributes thereof. Accordingly, reference should be made to the following claims, rather than to the foregoing specification, as indicating the scope hereof.

1. An energy harvesting device, comprising:
a cantilevered shaft attachable horizontally to a body experiencing wave motion;
a resonator mass attached to a free end of the cantilevered shaft, the resonator mass to move with circular motion as the body experiences the wave motion;
an energy conversion system operatively coupled to the cantilevered shaft, the energy conversion system to generate electrical energy from two orthogonal motion components of the circular motion of the resonator mass; and
an energy storage device to store the electrical energy.

2. The energy harvesting device of claim 1, wherein the cantilevered shaft is perpendicular to a direction of travel of waves that generate the wave motion of the body.

3. The energy harvesting device of claim 1, wherein the cantilevered shaft is mounted on an interior sidewall of the body.

4. The energy harvesting device of claim 1, wherein the cantilevered shaft is mounted to a vertical interior surface of the body.

5. The energy harvesting device of claim 1, wherein a resonator mass position is adjustable along a length of the cantilevered shaft.

6. The energy harvesting device of claim 5, wherein the resonator mass is positioned along the length of the cantilevered shaft so a resonance frequency of the energy harvesting device matches a frequency of the wave motion of the body.

7. The energy harvesting device of claim 1, wherein:
the energy conversion system comprises:
a first piezoelectric patch on a first side of the cantilevered shaft, the first piezoelectric patch to generate electrical energy from a horizontal motion component of the circular motion of the cantilevered shaft; and
a second piezoelectric patch on a second side of the cantilevered shaft, the second piezoelectric patch to generate electrical energy from a vertical motion component of the circular motion of the cantilevered shaft; and
the second side of the cantilevered shaft is orthogonal to the first side of the cantilevered shaft.

8. The energy harvesting device of claim 1, wherein the energy conversion system comprises:
a shaft gear with a radial slot to receive the cantilevered shaft, the shaft gear to rotate as the resonator mass moves with circular motion;
a generator gear with teeth that enmesh with the shaft gear;
a rotary generator operatively connected to the generator gear; and
a bearing having a stationary outer ring coupled to a support base for the shaft gear and a rotating inner ring coupled to a planar surface of the shaft gear.

9. The energy harvesting device of claim 1, further comprising:
a second cantilevered shaft attachable horizontally to the body;
a second resonator mass attached to a free end of the second cantilevered shaft, the second resonator mass to move with circular motion as the body experiences the wave motion; and
a second energy conversion system operatively coupled to the second cantilevered shaft, the second energy conversion system to generate electrical energy from two orthogonal motion components of the circular motion of the second resonator mass.

10. An energy harvesting device, comprising:
a cantilevered shaft attachable horizontally to a body experiencing wave motion, the cantilevered shaft is perpendicular to a direction of the wave motion of the body;
a resonator mass attached to a free end of the cantilevered shaft, the resonator mass to move with circular motion as the body experiences the wave motion, an axis of the circular motion is perpendicular to the wave motion of the body;
an energy conversion system operatively coupled to the cantilevered shaft, the energy conversion system to generate electrical energy from:
a first orthogonal motion component of the circular motion of the resonator mass; and
a second orthogonal motion component of the circular motion of the resonator mass; and
an energy storage device to store the electrical energy.

11. The energy harvesting device of claim 10, wherein the cantilevered shaft is mounted on at least one of:
an interior sidewall of the body; or
a vertical interior surface of the body.

12. The energy harvesting device of claim 10, wherein:
a resonator mass position is adjustable along a length of the cantilevered shaft; and
the resonator mass is positioned along the length of the cantilevered shaft so a resonance frequency of the energy harvesting device matches a frequency of the wave motion of the body.

13. The energy harvesting device of claim 10, wherein:
the energy conversion system comprises:
a first piezoelectric patch on a first side of the cantilevered shaft, the first piezoelectric patch to generate electrical energy from a horizontal motion component of the circular motion of the cantilevered shaft; and
a second piezoelectric patch on a second side of the cantilevered shaft, the second piezoelectric patch to generate electrical energy from a vertical motion component of the circular motion of the cantilevered shaft; and
the second side of the cantilevered shaft is orthogonal to the first side of the cantilevered shaft.

14. The energy harvesting device of claim 10, wherein the energy conversion system comprises:
a shaft gear with a radial slot to receive the cantilevered shaft, the shaft gear to rotate as the resonator mass moves with circular motion;
a generator gear with teeth that enmesh with the shaft gear;
a rotary generator operatively connected to the generator gear; and
a bearing having a stationary outer ring coupled to a support base for the shaft gear and a rotating inner ring coupled to a planar surface of the shaft gear.

15. The energy harvesting device of claim 10, further comprising:
a second cantilevered shaft attachable horizontally to the body;
a second resonator mass attached to a free end of the second cantilevered shaft, the second resonator mass to move with circular motion as the body experiences the wave motion; and
a second energy conversion system operatively coupled to the second cantilevered shaft, the second energy conversion system to generate electrical energy from two orthogonal motion components of the circular motion of the second resonator mass.

16. A buoy comprising:
a body having an internal volume, the body experiences wave motion; and
an energy harvesting device, comprising:
a cantilevered shaft attachable horizontally to a body experiencing wave motion, the cantilevered shaft is perpendicular to a direction of the wave motion of the body;
a resonator mass attached to a free end of the cantilevered shaft, the resonator mass to move with circular motion as the body experiences the wave motion, an axis of the circular motion is perpendicular to the wave motion of the body;
an energy conversion system operatively coupled to the cantilevered shaft, the energy conversion system to generate electrical energy from:
a first orthogonal motion component of the circular motion of the resonator mass; and
a second orthogonal motion component of the circular motion of the resonator mass; and
an energy storage device to store the electrical energy.

17. The buoy of claim 16, wherein:
the energy conversion system comprises:
a first piezoelectric patch on a first side of the cantilevered shaft, the first piezoelectric patch to generate electrical energy from a horizontal motion component of the circular motion of the cantilevered shaft; and
a second piezoelectric patch on a second side of the cantilevered shaft, the second piezoelectric patch to generate electrical energy from a vertical motion component of the circular motion of the cantilevered shaft; and
the second side of the cantilevered shaft is orthogonal to the first side of the cantilevered shaft.

18. The buoy of claim 16, wherein the energy conversion system comprises:
a shaft gear with a radial slot to receive the cantilevered shaft, the shaft gear to rotate as the resonator mass moves with circular motion;
a generator gear with teeth that enmesh with the shaft gear;
a rotary generator operatively connected to the generator gear; and
a bearing having a stationary outer ring coupled to a support base for the shaft gear and a rotating inner ring coupled to a planar surface of the shaft gear.

19. The buoy of claim 16, further comprising an additional energy harvesting device having a second cantilevered shaft at a different angular orientation than the cantilevered shaft of the energy harvesting device.

20. The buoy of claim 16, further comprising an additional energy harvesting device having a resonance frequency that is different from a resonance frequency of the energy harvesting device.
